(19) United States
(12) Patent Application Publication
(10) Pub. No.: US 2017/0072697 A1
(43) Pub. Date: Mar. 16, 2017

(54) IMAGE FORMING APPARATUS

(71) Applicant: Funai Electric Co., Ltd., Osaka (JP)

(72) Inventor: Daisuke Ogawa, Osaka (JP)

(73) Assignee: Funai Electric Co., Ltd., Osaka (JP)

(21) Appl. No.: 15/267,941

(22) Filed: Sep. 16, 2016

(30) Foreign Application Priority Data
Sep. 16, 2015 (JP) 2015-183173

(51) Int. Cl. B41J 2/175; B41J 25/34

(52) U.S. Cl. CPC B41J 2/1752; B41J 25/34; B41J 2202/14

(57) ABSTRACT

An image forming apparatus includes a carriage that holds an ink cartridge; a first cover that pushes a first side of the ink cartridge downward; and a second cover that pushes a second side of the ink cartridge in a direction opposite to a paper feeding direction. The first cover includes a first engaging portion, the second cover includes a second engaging portion and a pinching portion and is openable by the pinching portion in the paper feeding direction, and the first cover and the second cover push the ink cartridge when the first engaging portion and the second engaging portion are engaged and the second cover is closed.

### BACKGROUND OF THE INVENTION

Field of the Invention

The present invention relates generally to an image forming apparatus, and particularly relates to an image forming apparatus provided with a carriage wherein an ink cartridge can be detached.

Description of the Related Art

An image forming apparatus with a carriage that carries a detachable ink cartridge is generally known (for example, see patent document 1).

A printing device (image forming apparatus) that has such a carriage is disclosed in the aforementioned patent document 1. A front cover covering the front surface and one side surface of an ink cartridge, and a top cover covering the top surface of an ink cartridge are provided on the carriage of the printing device. The front cover is attached to the carriage that can be freely opened and closed in the horizontal direction by rotating in the horizontal direction around an axis line parallel to the vertical direction. The top cover is attached to the carriage so as to be opened upward along with the opening operation of the front cover. This printing device allows the ink cartridge to be detached and replaced from the front surface side of the ink cartridge by the front cover openable in the horizontal direction.

### [Patent Document]

[Patent Document 1] Japanese Unexamined Patent Application Publication No. 2004-181918

### SUMMARY

However, in the printing device described in the aforementioned patent document 1, in order to replace the ink cartridge from the front surface side, it is necessary to open the printing device by rotating the front cover in the horizontal direction. In this case, because it is necessary to make room in the horizontal direction (lateral direction) for opening the front cover, the device increases in size in the horizontal direction (lateral direction).

An image forming apparatus according to one or more embodiments of the invention allows an ink cartridge to be replaced from the front surface side while suppressing the increase of size of the device in the horizontal direction (lateral direction).

The image forming apparatus according to one aspect of the invention comprises a carriage in which an ink cartridge can be detached, wherein the carriage includes: a carriage body portion for holding the ink cartridge; an upper member, disposed on the upper side of the carriage body portion, pushing the ink cartridge to the carriage body portion from above; and a front member disposed on the front side of the carriage body, pushing the ink cartridge to the carriage body from the front, and configured so as to open and close in an anteroposterior direction; wherein the front member has an opening and closing operation portion disposed on the front side of the front member to open and close the front member.

The image forming apparatus according to one aspect of the invention, as described above, comprises a front member configured so as to open and close in an anteroposterior direction. Thus, unlike the case where the front member is opened and closed in a horizontal direction, it is not necessary to make room in the horizontal direction (lateral direction) for opening and closing the front member. As a result, an ink cartridge can be replaced from the front surface side while suppressing an increase in size of the device in the horizontal direction (lateral direction). In addition, an opening and closing operation portion for opening and closing the front member is provided on the front surface side of the front member. Thus, unlike the case where the opening and closing operation portion is disposed on the upper surface side and the bottom surface side of the front member, it is not necessary to make room in the vertical direction for operating the opening and closing operation portion. As a result, an ink cartridge can be replaced from the front surface side while suppressing an increase in size of the device in the vertical direction.

In the image forming apparatus according to the aforementioned aspect, the upper member has a first engaging portion; the front member further has a second engaging portion for engaging the first engaging portion; the front member and the upper member are configured so that the ink cartridge is fixed to the carriage body portion due to the first engaging portion and the second engaging portion being engaged; the opening and closing operation portion includes a pinching portion; and the image forming apparatus is configured so that the engagement between the first engaging portion and the second engaging portion is released by pinching the pinching portion. According to this configuration, since the engagement between the first engaging portion and the second engaging portion can be released by simply pinching the pinching portion, the engaged state of the front member can easily be released.

In this case, a rotary shaft for rotating the pinching portion and the second engaging portion is provided on the pinching portion side between the pinching portion and the second engaging portion, and the image forming apparatus is configured so that, by pinching the pinching portion, the pinching portion rotates around the rotary shaft in a narrowing direction, and the engagement between the first engaging portion and the second engaging portion is released due to the second engaging portion rotating around the rotary shaft in a widening direction. According to this configuration, since the second engaging portion can rotate greatly by only pinching the pinching portion slightly, the engagement between the first engaging portion and the second engaging portion can be easily released.

In the image forming apparatus according to the aforementioned aspect, the front member further has an arm portion (or arm member); the upper member, when the front member is opened to the front, is configured so as to hold the ink cartridge, and has an elevated portion contacting the arm portion; and the arm portion on the front member is configured so that when the front member is opened to the front, the arm portion contacts the elevated portion of the upper member, and by lifting the upper member, the front portion of the ink cartridge that is held by the upper member is lifted up. According to this configuration, since the ink cartridge can be detached in an orientation inclined in an upward direction, the ink cartridge can easily be detached. In addition, since the front portion of the ink cartridge that is held by the upper member can be lifted by the arm portion of the front member along with the opening of the front member, the operability of replacing the ink cartridge can be improved compared to a case where opening the front member and lifting the front portion of the ink cartridge are carried out separately.

In this case, the arm portion of the front member has a structure movable in a direction in which the arm portion that is contacting the elevated portion of the upper member is separated from the elevated portion when the front member is closed to the rear. In this configuration, even though the arm portion is contacting the elevated portion of the upper member when the front member is closed to the rear, the contacting arm portion can move in a direction that separates from the elevated portion. As a result, it is possible to suppress being unable to close the front member due to interference between the elevated portion of the upper member and the arm portion.

In a configuration having a structure movable in a direction in which the arm portion separates from the elevated portion, the arm portion of the front member has, a biasing portion for biasing the arm portion moved in a direction that separates from the elevated portion, using a structure that can move in the direction that separates from the elevated portion, in an opposite direction of the direction separated from the elevated portion. According to this configuration, the arm portion can be returned to the original position due to the biasing portion even through the arm portion moves in a direction that separates from the elevated portion. As a result, the operability of replacing the ink cartridge can be improved compared to a case where a user returns the arm portion that moved in a direction separated from the elevated portion to the original position. In addition, since it is possible to suppress the arm portion from remaining in a state moved in a direction separated from the elevated portion when then opening the front member, it is possible to suppress the inability to lift the upper member using the arm portion.

In the configuration having a structure movable in a direction in which the arm portion is separated from the elevated portion, the elevated portion on the top member has an inclined surface guiding the arm portion contacting the elevated portion in a direction that separates from the elevated portion. According to this configuration, the arm portion contacting the elevated portion can be reliably moved in a direction that separates from the elevated portion of the front member. As a result, it is possible to reliably suppress being unable to close the front member due to interference between the elevated portion of the upper member and the arm portion.

According to one or more embodiments of the present invention, as described above, it is possible to provide an image forming apparatus that can replace an ink cartridge from the front surface side while suppressing an increase in size of the device in the horizontal direction (lateral direction).

### BRIEF DESCRIPTION OF THE DRAWINGS

FIG. 1 is a perspective view illustrating an overall configuration of an image forming apparatus according one or more embodiments of the present invention;

FIG. 2 is a perspective view illustrating a carriage according one or more embodiments of the present invention;

FIG. 3 is a side view illustrating a state in which the front member of a carriage according to one or more embodiments of the present invention is closed;

FIG. 4 is a side view illustrating a state in which the front member of a carriage according to one or more embodiments of the present invention is opened;

FIG. 5 is a planar view illustrating a state before the pinching portion of the engaging member of a carriage according to one or more embodiments of the present invention is pinched;

FIG. 6 is a planar view illustrating a state in which the pinching portion of the engaging member of a carriage according to one or more embodiments of the present invention is pinched;

FIG. 7 is a perspective view illustrating a carriage according one or more embodiments of the present invention;

FIG. 8 is a perspective view illustrating the arm member of a carriage according one or more embodiments of the present invention;

FIG. 9 is a perspective view illustrating the upper member of a carriage according one or more embodiments of the present invention;

FIG. 10 is a side view illustrating a state in which the front member of a carriage according to one or more embodiments of the present invention is closed;

FIG. 11 is a side view illustrating a state lifting the upper member using the arm member of the front member of a carriage according to one or more embodiments of the present invention;

FIG. 12 is a side view illustrating a state in which the front member of a carriage according to one or more embodiments of the present invention is opened;

FIG. 13 is a planar view illustrating a state in which the arm member of a front member and the elevated portion of an upper member according to one or more embodiments of the present invention are in contact;

FIG. 14 is a planar view illustrating a state in which the arm member of a front member moves in a direction that separates from the elevated portion of an upper member according to one or more embodiments of the present invention;

FIG. 15 is a perspective view illustrating a carriage according one or more embodiments of the present invention; and

FIG. 16 is a perspective view illustrating the arm member of a carriage according to one or more embodiments of the present invention.

### DETAILED DESCRIPTION

Embodiments embodying the present invention will be described below based on drawings.

### FIRST EXAMPLE

### (Configuration of the Image Forming Apparatus)

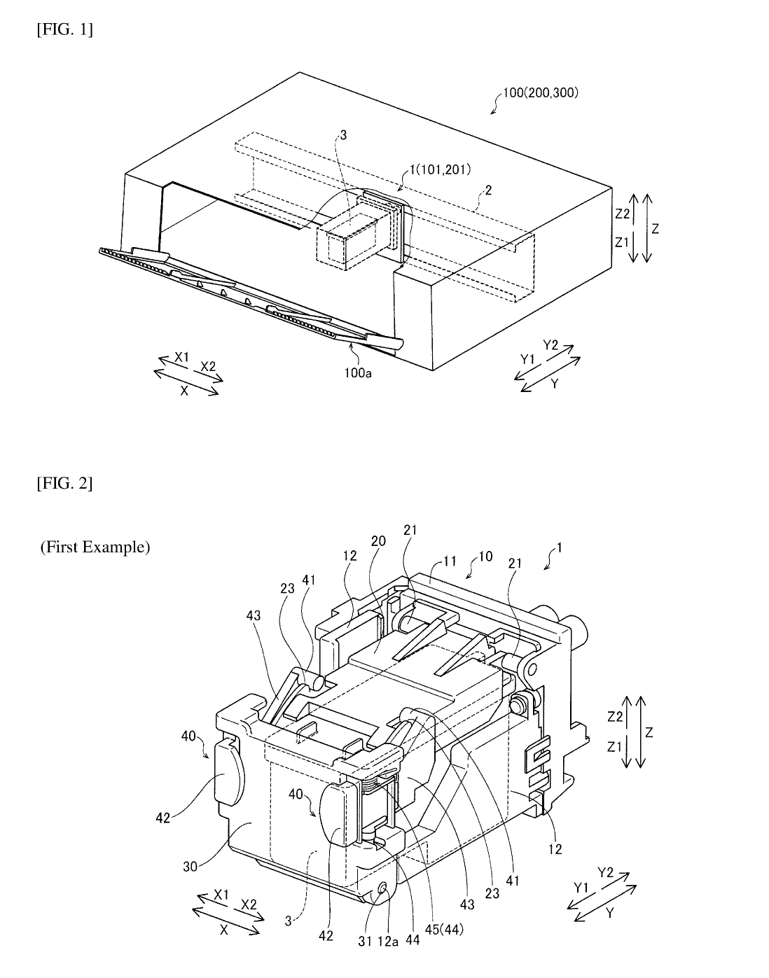

First, the configuration of an image forming apparatus 100 according to one or more embodiments of the first example of the present invention will be described with reference to FIG. 1.

The image forming apparatus 100 according to one or more embodiments of the first example of the present invention is an inkjet type image forming apparatus for forming (printing) an image on paper by spraying droplets of ink. As illustrated in FIG. 1, the image forming apparatus 100 according to one or more embodiments in this example comprises a carriage 1, and a rail portion 2 extending along a horizontal direction (X-direction).

The carriage 1 is configured so that an ink cartridge 3 is detachably mounted. In addition, the carriage 1 is attached to the rail portion 2 to be movable along the rail portion 2. Furthermore, the carriage 1 is configured so as to move along the rail portion 2 using a drive mechanism, not illustrated.

The image forming apparatus 100 is configured so as to form an image on a paper by spraying droplets of ink from the ink cartridge 3 mounted on the carriage 1 while moving the carriage 1 along the rail portion 2.

In addition, a front cover 100a that can open and close is provided on the front side (Y1 side) of the image forming apparatus 100 in an anteroposterior direction (Y direction). The front cover 100a is opened when replacing the ink cartridge 3 mounted on the carriage 1. Then, the ink cartridge 3 is detached from the front side of the ink cartridge 3, and replaced.

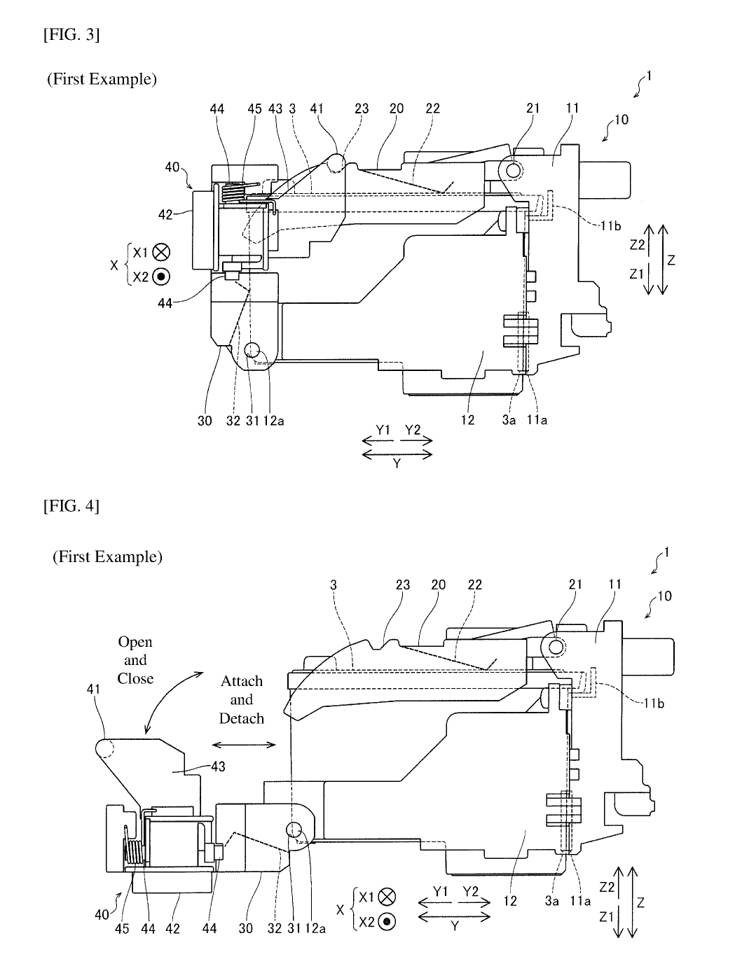

In the present specification, an electrode surface 3a (see FIG. 3) side, described hereinafter, of the ink cartridge 3 shall be the back side (Y2 direction), and the opposite direction of the back side shall be the front side (Y1 direction). In addition, the direction that the rail portion 2 extends shall be the horizontal direction (lateral direction, X direction), and the direction perpendicular to the X direction and the Y direction shall be the vertical direction (Z direction). In addition, the top surface side of the ink cartridge 3 shall be the upper side (Z2 direction) and the bottom surface side shall be the lower side (Z1 direction).

### (Configuration of the Carriage)

As illustrated in FIG. 2 through FIG. 6, the carriage 1 includes a carriage body portion 10, an upper member 20 (or first cover), and a front member 30 (or second cover). The carriage body portion 10 is provided so as to cover the back side (Y2 side) of the ink cartridge 3 and both sides (X1 side and X2 side) in the horizontal direction. In addition, the upper member 20 is provided so as to cover the upper side (Z2 side) of the ink cartridge 3. Furthermore, the front member 30 is provided so as to cover the front side (Y1 side) of the ink cartridge 3.

The carriage body portion 10 is configured so as to hold the ink cartridge 3. In addition, the carriage body portion 10 has a back member 11 and a pair of side members 12.

As illustrated in FIG. 3 and FIG. 4, the back member 11 is disposed on the back surface side (Y2 side) of the ink cartridge 3. In addition, as illustrated in FIG. 3 and FIG. 4, an electrode surface 11a electrically connected to an electrode surface 3a of the ink cartridge 3 is provided in the back member 11 on the inner surface facing the ink cartridge 3. Furthermore, a receiving portion 11b for holding the ink cartridge 3 is provided on the inner side (ink cartridge 3 side) of the back member 11. The receiving portion 11b is configured so as to hold the back portion of the ink cartridge 3 from below using the upper surface.

As illustrated in FIG. 2 through FIG. 6, the pair of side members 12 are respectively provided on both sides of the ink cartridge 3 in the horizontal direction (X direction). In addition, the pair of side members 12 is attached to the back member 11 by the end portions of the back side (Y2 side). Furthermore, the pair of side members 12 is configured so as to hold the ink cartridge 3 using the receiving portion, not illustrated.

The upper member 20 is disposed on the upper side (Z2 side) of the carriage body portion 10. In addition, the upper member 20 is configured so as to push the ink cartridge 3 to the carriage body portion 10 from above (Z2 or downward direction).

A pair of support members 21 extending in the horizontal direction are provided on both sides of the back portion of the upper member 20 in the horizontal direction (X direction). The upper member 20 is attached to the upper portion of the back member 11 via the pair of support members 21.

In addition, as illustrated in FIG. 3 and FIG. 4, a pushing member 22 made from a plate spring is provided on the inner surface of the upper member 20. The pushing member 22 is configured so as to contact the top surface (surface on the Z2 side) of the ink cartridge 3, and to push (bias) the ink cartridge 3 to the lower side (Z1 direction) from the upper side (Z2 direction). As a result, the ink cartridge 3 is pushed to the receiving portion, not illustrated, of the side members 12 and the receiving portion 11b of the back member 11, and is fixed to the carriage body portion 10 so as to not shift in the vertical direction.

In addition, as illustrated in FIG. 2 through FIG. 6, a pair of engaging portions 23 made from concave portions is provided on both sides of the front portion of the upper member 20 in the horizontal direction. The pair of engaging portions 23 are engaged to engaging portions 41 of a pair of engaging members 40, described later, and are configured so as to be fixed in a state in which the front member 30 is closed. The engaging portions 23 and the engaging portion 41 are respectively an example of the “first engaging portion” and the “second engaging portion” in the scope of patent claims.

The front member 30 is disposed on the front side (Y1 side) of the carriage body portion 10. In addition, the front member 30 is configured so as to push the ink cartridge 3 to the carriage body portion 10 from the front side (Y1 direction or a paper feeding direction).

Here, in one or more embodiments of the first example, the front member 30 is configured so as to open and close in an anteroposterior direction (Y direction) In addition, the front member 30 has a pair of pinching portions 42, described later, provided for opening and closing the front member 30 in the anteroposterior direction, disposed on the front side (Y1 side) of the front member 30. The pinching portions 42 are an example of the “opening and closing operation portion” in the scope of patent claims.

A pair of support portions 31 made from circular holes is provided on both sides of the lower portion of the front member 30 in the horizontal direction (X direction). In addition, a support shaft 12a extending in the horizontal direction (X direction) is provided on the front portion of the side member 12 on the carriage body portion 10 so as to correspond to the pair of support portions 31 on the front member 30. The front member 30 is attached to the support shaft 12a on the side member 12 to be able to pivot or rotate around the support shaft 12a via the support portion 31. The front member 30, as illustrated in FIG. 3 and FIG. 4, opens to the front side by rotating to the front side (Y1 side) from a closed state, and closes to the back side by rotating to the back side (Y2 side) from an open state.

In addition, a pushing member 32 made from a plate spring is provided on the inside of the front member 30. The pushing member 32 is configured so as to contact the front surface (surface of Y1 side) of the ink cartridge 3, and to push (bias) the ink cartridge 3 to the back side (Y2 direction) from the front side (Y1 direction). As a result, the ink cartridge 3 is pushed to the inside surface of the back member 11 facing the ink cartridge 3, and is fixed to the carriage body portion 10 so as to not shift in the anteroposterior direction. In addition, as a result of the pushing, it is possible for the electrode surface 3a of the ink cartridge 3 and the electrode surface 11a of the back member 11 to reliably come in contact.

In addition, a pair of engaging members 40 extending to the back side from the front member 30 are provided on both sides of the upper portion of the front member 30 in the horizontal direction (X direction). The pair of engaging members 40 has a mirror image symmetrical structure.

Engaging portions 41 having a cylindrical shape extending to the inside (ink cartridge 3 side) in the horizontal direction (X direction) are each provided in the back portion of the pair of engaging members 40. The engaging portions 41 are engaged to engaging portions 23 on the upper member 20, and are configured so as to fix the front member 30 in a closed state.

In addition, pinching portions 42 are each provided on the front portion of the pair of engaging members 40 for releasing the engagement between the engaging portions 23 of the upper member 20 and the engaging portions 41 of the engaging members 40, by being pinched by the user. The pinching portions 42 of the front portion of the engaging members 40 and the engaging portions 41 of the back portion of the engaging members 40 are connected via a connecting portion 43 extending in the anteroposterior direction.

In addition, on the pair of engaging members 40, rotary shafts 44 are each provided between the engaging portions 41 and the pinching portions 42 for rotating the engaging portions 41 and the pinching portions 42. The rotary shafts 44 are provided on the near side of the pinching portions 42 between the engaging portions 41 and the pinching portions 42. In addition, the rotary shafts 44 have a cylindrical shape extending in the vertical direction (Z direction), and are provided in a pair on both sides of the engaging members 40 in the vertical direction. In addition, the engaging members 40 are attached to the front member 30 to be able to pivot or rotate around the rotary shafts 44 via the rotary shafts 44.

In addition, biasing members 45 made from torsion springs are attached to the rotary shafts 44 on the upper side (Z2 side) of the engaging members 40. The biasing members 45 are configured so as to bias in a direction (inside of horizontal direction) to push back to the back portion of the engaging members 40 when the back portion (engaging portion 41 side) of the engaging members 40 opens to the outside in the horizontal direction (X direction). On the other hand, the biasing members 45 apply a bias force to maintain the engagements of the engaging portions 23 and the engaging portions 41.

In one or more embodiments of the first example, the upper member 20 and the front member 30 are configured so that, by the engaging portions 23 of the upper member 20 and the engaging portion 41 of the engaging member 40 engaging, they are pushed by the pushing member 22 of the upper member 30 and the pushing member 32 of the front member 30, fixing the ink cartridge 3 to the carriage body portion 10 by pushing. In other words, when the both engaging portions are engaged, a front part of the engaging portion 23 on a side of Y1 direction contacts a part of the engaging portion 41 and is subject to a biasing force from the part of the engaging portion 41 in Y2 direction, and a bottom part of the engaging portion 23 on a side of Z1 direction contacts another part of the engaging portion 41 and is subject to another biasing force from the other part of the engaging portion 41 in Z2 direction.

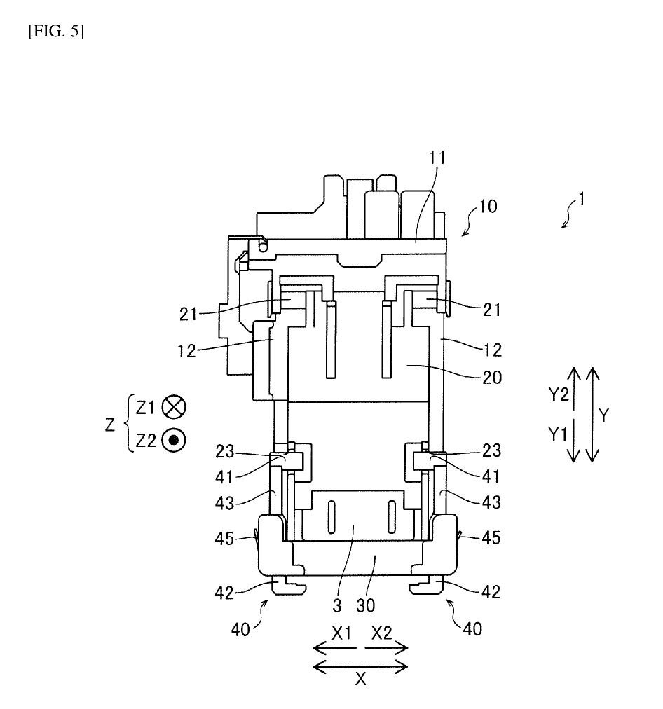

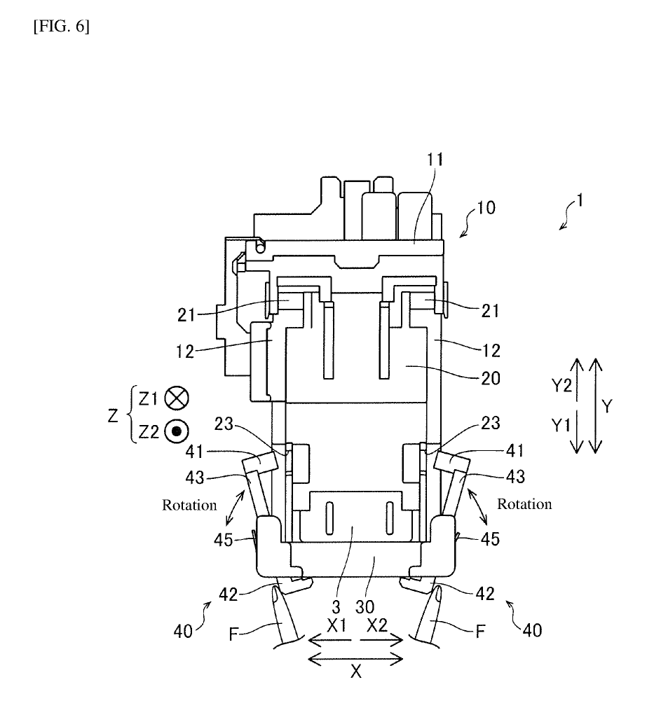

In addition, in one or more embodiments of the first example, as illustrated in FIG. 5 and FIG. 6, the carriage 1 is configured so that the engagement between the engaging portions 23 of the upper member 20 and the engaging portions 41 of the engaging members 40 is released by the pair of pinching portions 42 on the engaging members 40 being pinched by a finger F (see FIG. 6) of the user from both sides in the horizontal direction (X direction).

In detail, the carriage 1 is configured so that the pair of pinching portions 42 rotate around the rotary shafts 44 in a narrowing direction (direction in which the pair of pinching portions 42 come closer to each other) by the pair of pinching portions 42 on the engaging members 40 being pinched from both sides in the horizontal direction (X direction), and the pair of pinching portions 41 rotating around the rotary shafts 44 in a widening direction (direction in which the pair of pinching portions 41 separate from each other). As a result, in the carriage 1, the engagement between the engaging portions 23 of the upper member 20 and the engaging portions 41 of the engaging members 40 is released.

### (Attachment and Detachment of the Ink Cartridge)

Next, the attaching and detaching operation of the ink cartridge 3 in the image forming apparatus 100 according to one or more embodiments of the first example will be described with reference to FIG. 3, FIG. 4 and FIG. 6.

FIG. 3 illustrates a state in which the ink cartridge 3 is attached and fixed to the carriage 1. In this state, the engaging portions 23 of the upper member 20 and the engaging portions 41 of the engaging members 40 are engaged, and the front member 30 is in a closed state. From this state, when removing the ink cartridge 3, as illustrated in FIG. 6, the pair of pinching portions 42 of the engaging members 40 are pinched by a finger F (see FIG. 6) of the user from both sides in the horizontal direction (X direction). Thus, the engagement between the engaging portions 23 of the upper member 20 and the engaging portions 41 of the engaging members 40 is released, and the front member 30 can be opened to the front side.

FIG. 4 illustrates a state in which the front member 30 is opened. In this state, since the front member 30 is opened, the ink cartridge 3 can be pulled out to the front side (Y1 direction) and can be removed from the carriage 1. In addition, the ink cartridge 3 can be inserted to the back side (Y2 direction), and can be attached to the carriage 1.

Then, the front member 30 is closed on the back side in a state in which the ink cartridge 3 is mounted to the carriage 1. Thus, the engaging portions 23 of the upper member 20 and the engaging portions 41 of the engaging members 40 are engaged, and the ink cartridge 3 is fixed to the carriage 1.

### EFFECT OF FIRST EXAMPLE

The following effects can be obtained in one or more embodiments of the first example.

In one or more embodiments of the first example, as described above, a front member 30 configured so as to open and close in the anteroposterior direction is provided. Thus, unlike a case where the front member 30 is opened and closed in the horizontal direction, it is not necessary to make room in the horizontal direction for opening and closing the front member 30. As a result, it is possible to replace the ink cartridge 3 from the front side while suppressing an increase in size of the device in the horizontal direction. In addition, pinching portions 42 are provided for opening and closing the front member 30 on the front side of the front member 30. Thus, unlike a case where the pinching portions 42 are disposed on the upper side and lower side of the front member 30, it is not necessary to make room in the vertical direction for operating the pinching portion. As a result, it is possible to replace the ink cartridge 3 from the front side while suppressing an increase in size of the device in the vertical direction.

In addition, in one or more embodiments of the first example, as described above, the upper member 20 has engaging portions 23. Also, the front member 30 has engaging portions 41 engaging the engaging portions 23. Also, the front member 30 and upper member 20 are configured so as to fix the ink cartridge 3 to the carriage body portion 10 by the engaging portions 23 and the engaging portions 41 being engaged. Also, the carriage 1 is configured so that the engagement between the engaging portions 23 and the engaging portions 41 is released by the pinching portions 42 being pinched. Thus, since the engagement between the engaging portions 23 and the engaging portions 41 can be released by simply pinching the pinching portions 42, the engaged state of the front member 30 can easily be released.

In addition, in one or more embodiments of the first example, as described above, rotary shafts 44 are provided on the pinching portion 42 side between the pinching portions 42 and the engaging portions 41, for rotating the pinching portions 42 and the engaging portions 41. Also, the carriage 1 is configured so that the pinching portions 42 rotate around the rotary shafts 44 in a narrowing direction by the pinching portions 42 being pinched, and the engagement of between the engaging portions 23 and the engaging portions 41 is released by the engaging portion s41 rotating around the rotary shafts 44 in a widening direction. Thus, since the engaging portions 41 can rotate greatly by only pinching the pinching portions 42 slightly, the engagement between the engaging portions 23 and the engaging portions 41 can easily be released.

### SECOND EXAMPLE

Next, one or more embodiments of the second example will be described with reference to FIG. 1 and FIG. 7 through FIG. 14. In one or more embodiments of the second example, in addition to the configuration of the embodiments of the aforementioned first example, an example in which an arm member is further provided on the carriage for lifting the upper member will be described.

### (Configuration of the Image Forming Apparatus)

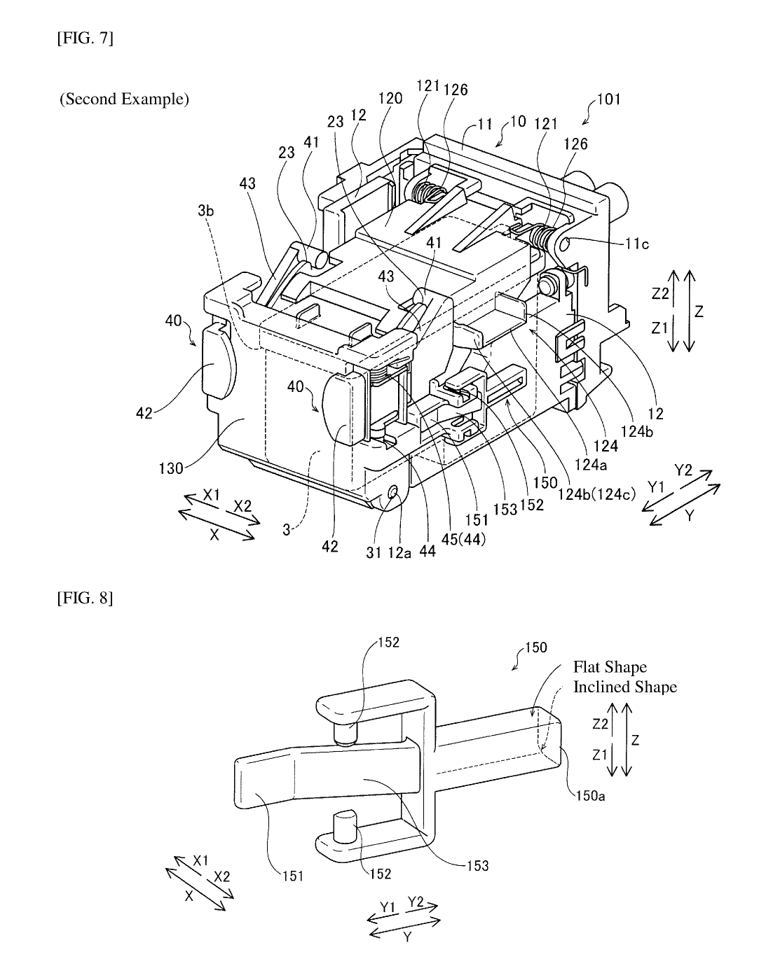

The image forming apparatus 200 according to one or more embodiments of the second example of the present invention, as illustrated in FIG. 1, differs from the image forming apparatus 100 according to the embodiments of the aforementioned first example in that the image forming apparatus 200 comprises a carriage 101. In addition, as illustrated in FIG. 7, the carriage 101 differs from the carriage 1 according to the embodiments of the aforementioned first example in that the carriage 101 comprises an upper member 120 and the front member 130. A similar configuration as the embodiments of the aforementioned first example will be denoted by the same reference numerals and a description thereof will be omitted.

### (Configuration of the Carriage)

As illustrated in FIG. 7, FIG. 8 and FIG. 10 through FIG. 14, in one or more embodiments of the second example, an arm member 150 is provided on the front member 130 for lifting the upper member 120 in an upper direction (Z2 direction). The arm member 150 is formed so as to extend from the front member 130 to the back, disposed on the lower side (Z1 side) of the engaging members 40. In addition, the arm member 150 is provided only on one side (X2 side) in the horizontal direction of the front member 130.

In addition, as illustrated in FIG. 7 and FIG. 9 through FIG. 14, in one or more embodiments of the second example, an elevated portion 124 is provided on the side surface on the X2 side of the upper member 120. The elevated portion 124 is configured so as to contact the arm member 150 on the front member 130 when the front member 130 is opened to the front side (Y1 direction). The elevated portion 124 is configured by a plate shaped portion 124a extending in the horizontal direction (X direction) and the anteroposterior direction (Y direction), and by a pair of side portions 124b extending to the upwards from both end portions of the plate shaped portion 124a in the anteroposterior direction. In addition, the elevated portion 124 is formed so as to extend entirely in the X2 direction from the side surface on the X2 side of the upper member 120.

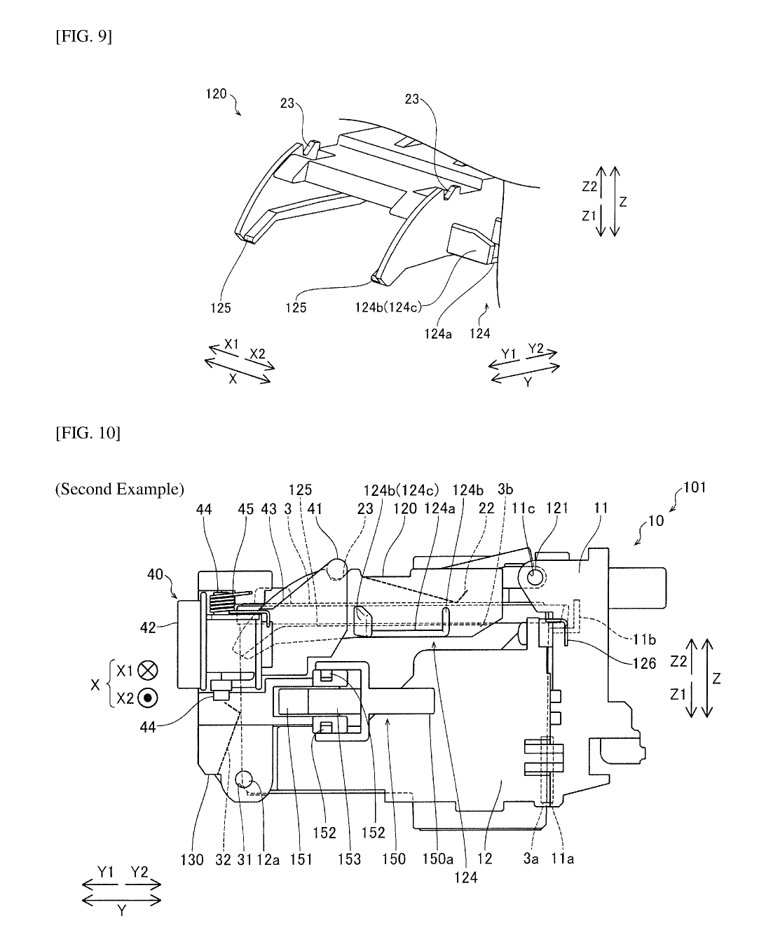

In addition, as illustrated in FIG. 9, a pair of rail portions 125 are provided on the side surface on the inside of the upper member 120. The pair of rail portions 125 are configured so as to hold the ink cartridge from the bottom (Z1 direction) by being in contact with a flange portion 3b (see FIG. 7) on the upper portion of the ink cartridge 3 when the front member 130 is opened to the front (Y1 direction). In addition, the pair of rail portions 125, in a state in which the front member 130 is completely closed (see FIG. 10), have a predetermined gap between the flange portions 3b on the ink cartridge 3, and are configured so as not to hold the ink cartridge 3.

Here, in one or more embodiments of the second example, as illustrated in FIG. 10 through FIG. 12, the arm member 150 on the front member 130 is configured so that the end portion 150a on the back side (Y2 side) of the arm member 150 contacts the bottom surface (surface on the Z1 side) of the plate shaped portion 124a on the elevated portion 124 when the front member 130 is opened to the front (Y1 direction), and the front portion of the ink cartridge 3 that is held by the upper member 120 is lifted by lifting the upper member 120. The plate shaped portion 124a on the elevated portion 124 is disposed on an arc shaped locus drawn by the end portion 150a on the back side (Y2 side) of the arm member 150, which rotates along with the rotation of the front member 130.

In addition, as illustrated by FIG. 10 through FIG. 12, a pair of rotary shafts 121 extending in the horizontal direction are provided on both sides in the horizontal direction (X direction) of the back portion of the upper member 120. In addition, a supporting portion 11c made from a circular hole is provided on the upper portion of the back member 11 on the carriage body portion 10, so as to correspond to the pair of rotary shafts 121 on the upper member 120. The upper member 120 is attached to the support portion 11c on the back member 11 to be able to rotate around the rotary shaft 121 via the rotary shaft 121.

In addition, a biasing member 126 made from a torsion spring is attached to the pair of rotary shafts 121 on the upper member 120. The biasing member 126 is configured for the biasing force to work so that the upper member 120 maintains an inclined upward orientation (see FIG. 12). In other words, the biasing member 126 is configured so as to bias in a direction (upward) pushing back the front portion of the upper member 120 when the front portion of the upper member 120 is closed on the bottom (Z1 side). Thus, since a detachable orientation of the ink cartridge 3 can be maintained, it is possible to easily replace the ink cartridge 3.

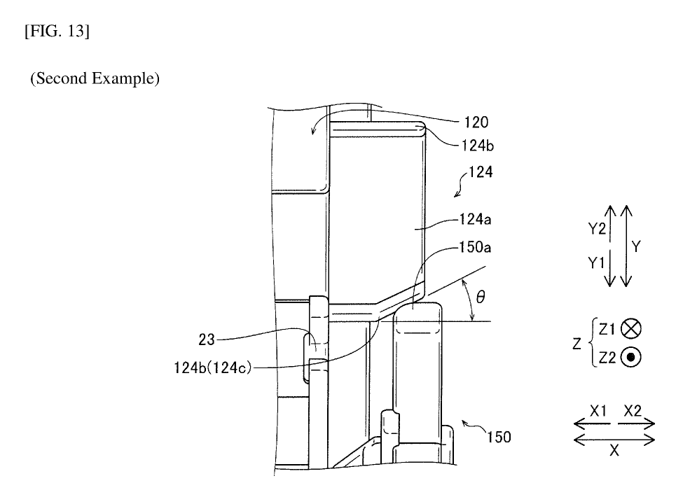

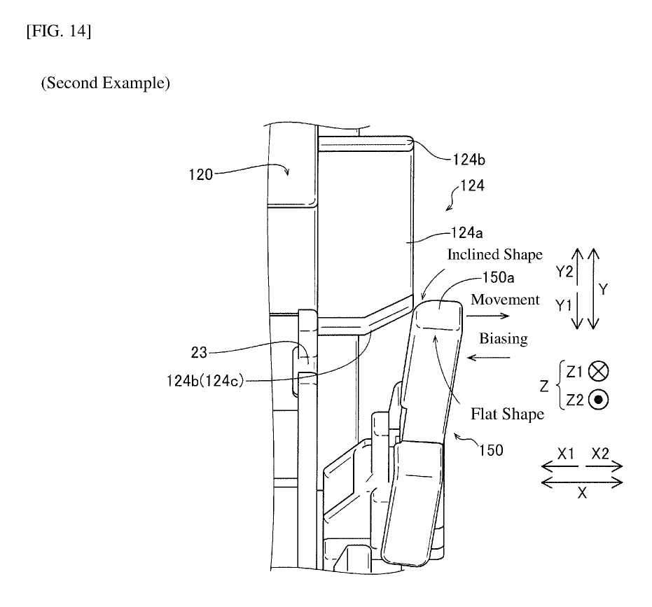

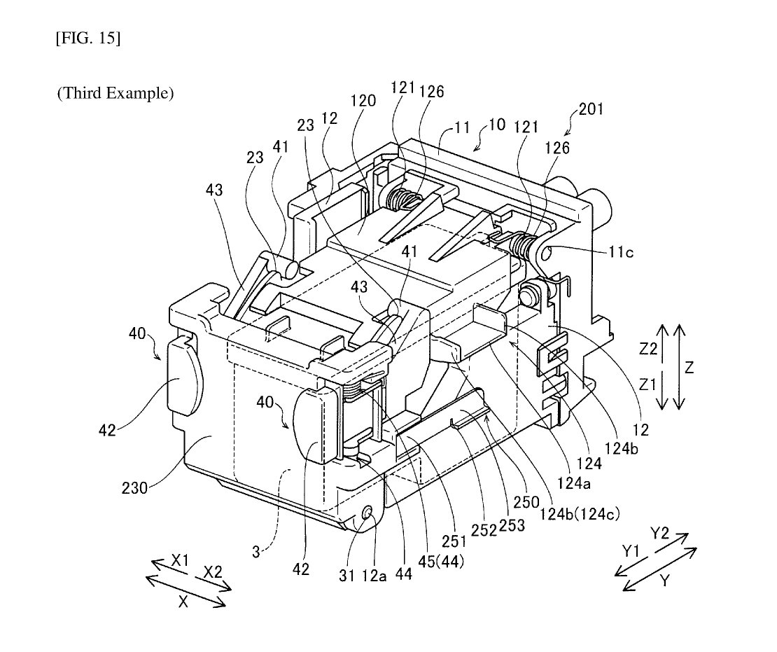

In addition, in one or more embodiments of the second example, as illustrated in FIG. 8, FIG. 13 and FIG. 14, a structure movable in a direction (X2 direction) in which the arm member 150 that is contacting the elevated portion 124 on the upper member 120 separates from the elevated portion 124, is provided on the arm member 150 when the front member 130 is closed to the back (Y2 direction).

For example, a contacting portion 151 contacting the side surface of the front side member 130 is provided on the front portion of the arm member 150. In addition, a biasing portion 153 is provided on the center portion of the arm member 150 so as to connect the pair of rotary shafts 152 extending in a vertical direction to the back portion of the contacting portion 151 and the arm member 150. The arm member 150 is attached to the front member 130 to be able to pivot or rotate around the rotary shaft 152 via the rotary shaft 152. Thus, the back portion of the arm member 150, when the arm member 150 is contacting the elevated portion 124 of the upper member 120, moves in a direction that separates from the elevated portion 124 due to the arm member 150 rotating around the rotary shaft 152.

As illustrated in FIG. 13 and FIG. 14, the biasing portion 153 on the arm member 150 is made from an elastic material such as a resin spring, and deforms and biases the arm member 150 that moved in a direction that separates from the elevated portion 124 due to a structure that can move in a direction (X2 direction) that separates from the elevated portion 124, in an opposite direction (X1 direction) of the direction that separates from the elevated portion.

In addition, in one or more embodiments of the second example, an inclined surface guiding the arm member 150 contacting the elevated portion 124 in a direction that separates from the elevated portion 124 is provided on the elevated portion 124 on the upper member 120. In detail, the inclined surface 124c is provided on a side portion 124b on the front side (Y1 side) of the elevated portion 124. In addition, the inclined surface 124c is inclined by a predetermined inclination angle θ on the back side (Y2 side) with respect to the horizontal direction (X direction or a direction in which the carriage 101 moves together with the ink cartridge 3 for printing). From the viewpoint of facilitating moving the arm member 150 in a direction (X2 direction) that separates from the elevated portion 124, an angular range of the inclination angle may be greater than or equal to about 5 degrees and less than or equal to about 70 degrees.

In addition, the upper portion of the end portion 150a on the back side (Y2 side) of the arm member 150 is formed in a flat shape in order to facilitate lifting the arm member 120, and the lower portion has an inclined shape (R shape) in order to facilitate moving in a direction that separates from the elevated portion 124.

### (Attachment and Detachment of the Ink Cartridge)

Next, the attaching and detaching operation of the ink cartridge 3 in the image forming apparatus 200 according to one or more embodiments of the second example will be described with reference to FIG. 10 through FIG. 14.

FIG. 10 illustrates a state in which the ink cartridge 3 is attached and fixed to the carriage 101. In this state, the engaging portions 23 of the upper member 120 and the engaging portions 41 of the engaging members 40 are engaged, and the front member 130 is in a closed state. From this state, when removing the ink cartridge 3, similar to FIG. 6 of the embodiments of the aforementioned first example, the pair of pinching portions 42 of the engaging members 40 are pinched by a finger F (see FIG. 6) of the user from both sides in the horizontal direction (X direction). Thus, the engagement between the engaging portions 23 of the upper member 120 and the engaging portions 41 of the engaging members 40 is released, and the front member 130 can be opened to the front.

In the state illustrated in FIG. 10, the back portion of the ink cartridge 3 is pushed to the receiving portion 11b on the back member 11, even when the engagement of the engaging portions 23 of the upper member 120 and the engaging portions 41 of the engaging members 40 is released. Thus, the upper member 120 is not lifted upwards unless lifted up by the arm member 150.

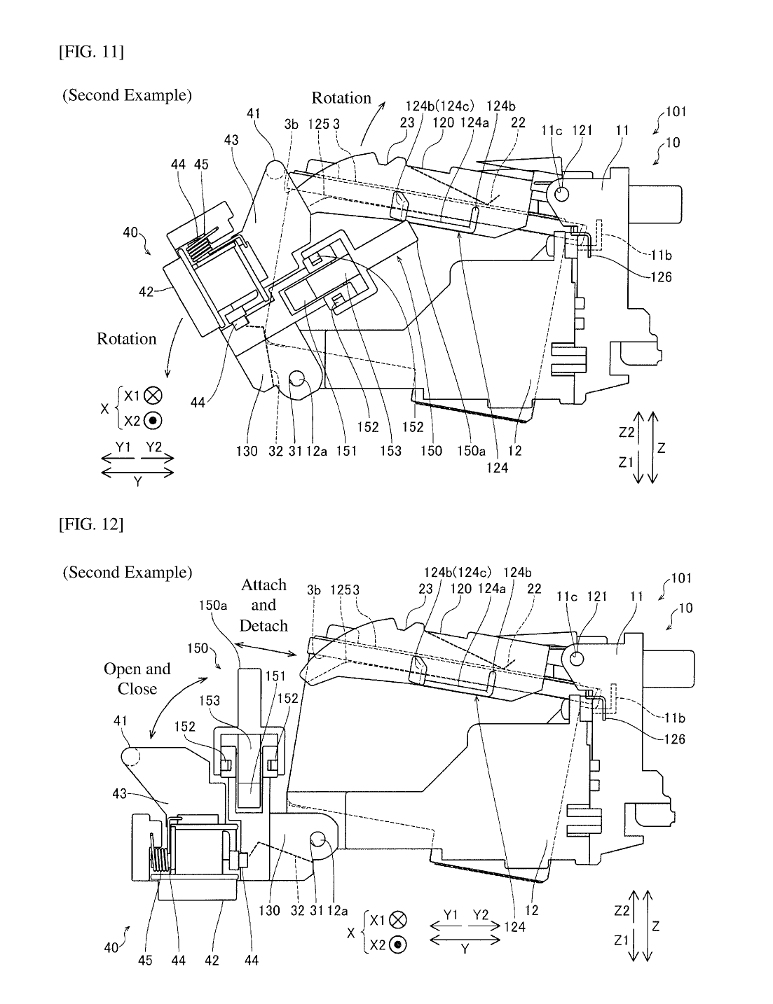

FIG. 11 illustrates a state lifting the upper member 120 using the arm member 150 of the front member 130. During the opening of the front member 130, the arm member 150 attached to the front member 130 also rotates with the opening of the front member 130. As a result, the elevated portion 124 on the upper member 120 disposed on the arc shaped locus drawn by the end portion 150a of the on the back side (Y2 side) of the arm member 150 contacts the end portion 150a on the back side of the arm member 150. Then, the upper member 120 is lifted upward by the arm member 150, and rotates around the rotary shaft 121 provided on the back portion of the upper member 120. At this time, the ink cartridge 3 is similarly lifted upwards by being held by the rail portion 125 on the upper member 120. In the state illustrated in FIG. 10, there is a predetermined gap between the rail portion 125 on the upper member 120 and the ink cartridge 3, and the ink cartridge 3 is gradually held by the rail portion 125 on the upper member 120 along with the opening of the front portion 130.

FIG. 12 illustrates a state in which the front member 130 is opened. In this state, the inclined upward orientation of the upper member 120 is maintained due to the biasing force of the biasing member 126 provided on the rotary shaft 121. In addition, similarly, the inclined upward orientation of the ink cartridge 3 held by the rail portion 125 on the upper member 120 is also maintained. Therefore, in one or more embodiments of the second example, it is possible to remove the ink cartridge 3 from the carriage 1 by inclining it upwards and extracted it to the front (Y1 direction). In addition, it is possible to attach (mount) the ink cartridge to the carriage 1 by inclining it downwards and inserting it to the back (Y2 direction). A configuration as such is effective since, for example, it is possible to incline the ink cartridge 3 upwards and remove it while avoiding obstacles, even when simply extracting the ink cartridge to the front is difficult due to obstacles such as a transport mechanism inside the image forming apparatus 200.

Also, the front member 130 is closed to the back in a state in which the ink cartridge 3 is mounted to the carriage 101. Thus, the engaging portions 23 of the upper member 120 and the engaging portions 41 of the engaging members 40 are engaged, and the ink cartridge 3 is fixed to the carriage 101.

### (Separating Operation of the Arm Member)

In addition, before the front member 130 is closed to the back, the orientation of the upper member 120 sometimes becomes inclined slightly downwards from an inclined upwards orientation due to an external force or the like. In this case, as illustrated in FIG. 13 and FIG. 14, when the front member 130 is closed to the back, the arm member 150 contacts the inclined surface 124c on the elevated portion 124 of the upper member 120. Then, the arm member 150 that is contacting the inclined surface 124c moves in a direction (X2 direction) that separates from the elevated portion 124.

For example, as illustrated in FIG. 13, first, when the front member 130 is closed to the back (Y2 direction), the inclined surface 124c on the elevated portion 124 and the end portion 150a on the back side of the arm member 150 come in contact. Also, as illustrated in FIG. 14, the back portion of the arm member 150 moves in a direction that separates from the elevated portion 124 by rotating around the rotary shaft 152. At this time, the back portion of the arm member 150 resisting the biasing force caused by the biasing portion 153 moves in a direction that separates from the elevated portion 124, in a state in which the contacting portion 151 on the opposite side of the back portion of the arm member 150 is contacting the side surface of the front member 130.

Also, the back portion of the arm member 150 further moves in a direction that separates from the elevated portion 124, being guided by the inclined surface 124c of the elevated portion 124. Then, when the front member 130 sufficiently rotates in a closing direction, the contact state of the inclined surface 124c on the elevated portion 124 is released. As a result, the back portion of the arm member 150 moves in an opposite direction (X1 direction) of the direction that separates from the elevated portion 124, due to the biasing force of the biasing portion 153. In other words, the arm member 150 returns to the original position.

Other configurations of the embodiments of the second example are similar to the embodiments of the aforementioned first example.

### EFFECT OF SECOND EXAMPLE

The following effects can be obtained in one or more embodiments of the second example.

In one or more embodiments of the second example, as described above, the front member 130 further has an arm member 150. Also, the upper member 120 is configured so as to hold the ink cartridge 3 when the front member 130 is opened to the front. Also, the upper member 120 further has an elevated portion 124 contacting the arm member 150 when the front member 130 is opened to the front. The arm member 150 on the front member 130 is configured so that the front portion of the ink cartridge 3 held by the upper member 120 is lifted up by lifting the upper member 120, contacting the elevated portion 124 on the upper member 120 when the front member 130 is opened to the front. Thus, since the ink cartridge 3 can be detached in an inclined upwards orientation, the ink cartridge 3 can easily be detached. In addition, since the front portion of the ink cartridge 3 held by the upper member 120 can be lifted by the arm member 150 on the front member 130 along with opening the front member 130, the operability of replacing the ink cartridge 3 can be improved compared to when separately opening the front member 130 and lifting the front portion of the ink cartridge 3.

In addition, in one or more embodiments of the second example, as described above, the arm member 150 contacting the elevated portion 124 on the upper member 120 provides a structure movable in a direction that separates from the elevated portion 124 to the arm member 150 on the front member 130, when the front member 130 is closed to the back. Thus, when the front member 120 is closed to the back, even if the arm member 150 contacts the elevated portion 124 on the upper member 120, the contacting arm member 150 can be moved in a direction that separates from the elevated portion 124. As a result, the arm member 150 interferes with the elevated portion 124 on the upper member 120, and it is possible to suppress the inability to close the front member 130.

In addition, in one or more embodiments of the second example, as described above, a biasing portion 153 is provided on the arm member 150 of the front member 130 for biasing the arm member 150 that moves in a direction that separates from the elevated portion 124 due to a structure that can move in a direction the separates from the elevated portion 124, in the opposite direction of the direction that separates from the elevated portion 124. Thus, even if the arm member 150 moves in a direction that separates from the elevated portion 124, the arm member 150 can be returned to the original position using the biasing portion 153. As a result, the operability of replacing the ink cartridge 3 can be improved compared to when the user returns the arm member that moved in a direction that separates from the elevated portion 124 to the original position. In addition, since it is possible to suppress the arm member 150 remaining moved in a direction that separates from the elevated portion 124, and when then opening the front member 130, it is possible to suppress not being able to lift the upper member 120 using the arm member 150.

In addition, in one or more embodiments of the second example, as described above, an inclined surface 124c guiding the arm member 150 contacting the elevated portion 124 in a direction that separates from the elevated portion 124 is provided on the elevated portion 124 on the upper member 120. Thus, the arm member 150 that is contacting the elevated portion 124 can easily be moved in a direction that separates from the elevated portion 124 on the front member 130. As a result, the arm member 150 interferes with the elevated portion 124 on the upper member 120, and it is possible to easily suppress the inability to close the front member 130.

Other effects of the embodiments of the second example are similar to the embodiments of the aforementioned first example.

### THIRD EXAMPLE

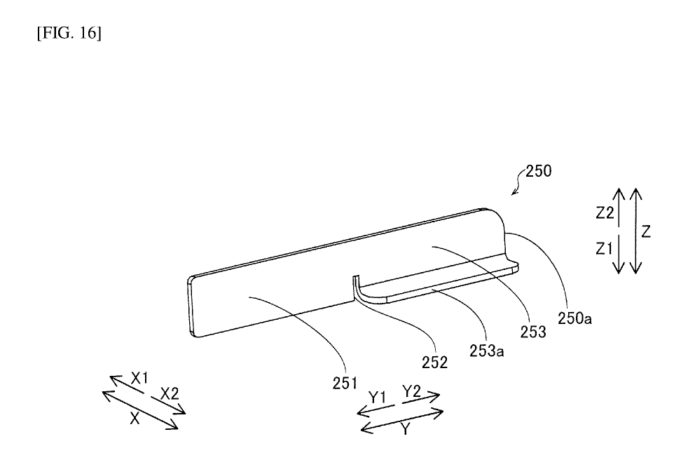

Next, one or more embodiments of the third example will be described with reference to FIG. 1, FIG. 15 and FIG. 16. In one or more embodiments of the third example, an example will be described in which an arm member differing from the embodiments of the aforementioned second example is provided on the carriage.

### (Configuration of the Image Forming Apparatus)

The image forming apparatus 300 according to one or more embodiments of the third example of the present invention, as illustrated in FIG. 1, differs from the image forming apparatus 200 according to the embodiments of the aforementioned second example in that the image forming apparatus 300 comprises a carriage 201. In addition, as illustrated in FIG. 15, the carriage 201 differs from the carriage 101 according to the embodiments of the aforementioned second example in that the carriage 201 comprises a front member 230. A similar configuration as the embodiments of the aforementioned second example will be denoted by the same reference numerals and a description thereof will be omitted.

### (Configuration of the Carriage)

As illustrated in FIG. 15 and FIG. 16, in one or more embodiments of the third example, an arm member 250 is provided on the front member 230 for lifting the upper member 120 upward (Z2 direction). The arm member 250 is formed so as to extend backward from the front member 230, disposed on the lower side (Z1 side) of the engaging members 40. In addition, the arm member 250 is provided only on one side (X2 side) in the horizontal direction of the front member 230.

In one or more embodiments of the third example, the arm member 250 on the front member 230 is roughly plate shaped. In addition, arm member 250 is configured so that the front portion of the ink cartridge 3 held by the upper member 120 is lifted up by lifting the upper member 120, by contacting the bottom surface (surface to the Z1 side) of the plate shaped portion 124a of the elevated portion 124 on the upper member 120 when the front member 130 is opened to the front. The plate shaped portion 124a of the elevated portion 124 is disposed on an arc shaped locus drawn by end portion 250a on the back side (Y2 side) of the arm member 250, which rotates along with the rotation of the front member 230.

In addition, in one or more embodiments of the third example, a structure movable in a direction (X2 direction) in which the arm member 250 that is contacting the inclined surface 124c of the elevated portion 124 on the upper member 120 is separated from the elevated portion 124, is provided on the arm member 250 when the front member 230 is closed to the back (Y2 direction).

For example, a contacting portion 251 contacting the side surface of the front side member 230 is provided in the front portion of the arm member 250. In addition, a notched portion 252 extending from the lower portion upward (Z2 direction) is provided in the center portion of the arm member 250. In addition, a biasing portion 253 is provided on the back portion of the arm member 250. The contacting portion 251 and the biasing portion 253 are disposed on opposite sides of each other, interposing the notched portion 252. In addition, the arm member 250 is attached to the front member 230 via the contacting portion 251.

The biasing portion 253 on the arm member 250 is made from a resin spring, and also serves as structure that can move in a direction (X2 direction) that separates from the elevated portion 124. In addition, the biasing portion 253 is configured so as to bias the arm member 250 that moves in the direction that separates from the elevated portion 124 in the opposite direction (X1 direction) of the direction that separates from the elevated portion 124.

In addition, a plate shaped portion 253a extending in the X direction from the lower portion is provided on the biasing portion 253 on the arm member 250. Since the lower portion of the biasing portion 253 and the end portion on the X1 side of the plate shaped portion 253a easily move in the direction that separates from the elevated portion 124, they are connected so as to have an inclined shape (R shape). In addition, the upper portion of the arm member 250 is formed to be flat, since the upper member 120 is easily lifted.

Other configurations of the embodiments of the third example are the same as the embodiments of the aforementioned second example.

### EFFECT OF THIRD EXAMPLE

The following effects can be obtained in one or more embodiments of the third example.

In one or more embodiments of the third example, as described above, the arm member 250 on the front member 230 is roughly plate shaped. Thus, since the arm member can be simplified, the formability of the arm member 250 can be improved. In addition, it is possible to obtain similar advantages to the arm member 150 according to the embodiments of the aforementioned second example even by using the arm member 250 according to the embodiments of the third example, by a structure that separates from the elevated portion 124 or a configuration such as the biasing portion 253.

Other effects of the embodiments of the third example are similar to the embodiments of the aforementioned first and second examples.

### [Variations]

In the embodiments disclosed herein, all the points are illustrative, and should be considered to be not restrictive. The scope of the present invention is illustrated by the scope of patent claims rather than the aforementioned embodiments, and furthermore, all changes (variations) within the meaning and scope equivalent to the scope of patent claims are included.

For example, in the embodiments of the aforementioned first through third examples, an example applying the present invention to an image forming apparatus that has a printing function is illustrated, but the present invention is not limited to this. The present invention may be applied to an image forming apparatus that also has a function other than a printing function separate from the printing function. For example, it may be applied to an image forming apparatus that also has a reading function for reading an image on paper separate from the printing function.

In addition, in the embodiments of the aforementioned first through third examples, an example in which the engagement between the engaging portion on the upper member and the engaging portion on the front member is released by pinching the pinching portion is illustrated, but the present invention is not limited to this. In one or more embodiments of the present invention, an opening and closing operation portion other than a pinching portion may be provided on the front surface side of the front member, and the engagement between the engaging portion on the upper member and the engaging portion on the front member may be released by an operation other than a pinching operation.

In addition, in the embodiments of the aforementioned first through third examples, an example in which the pinching portion rotates around the rotary shaft in a narrowing direction by being pinched, and the engagement between the engaging portion on the upper member and the engaging portion on the front member is released due to the engaging portion on the front member rotating around the rotary shaft in a widening direction, but the present invention is not limited to this. In one or more embodiments of the present invention, the engagement between the engaging portion on the upper member and the engaging portion on the front member may be released by an operation other than a rotary operation. For example, by pinching the pinching portion, the engagement between the engaging portion on the upper member and the engaging portion on the front member may be released by the pinching portion, and the engaging portion sliding in the horizontal direction.

In addition, in the embodiments of the aforementioned first through third examples, an example in which a pair of pinching portions is provided on both sides of the front member in the horizontal direction is illustrated, but the present invention is not limited to this. In one or more embodiments of the present invention, a pinching portion may be provided on only one side of the front member in the horizontal direction.

In addition, in the embodiments of the aforementioned second and third examples, an example in which a carriage is configured so that only the front portion of the ink cartridge is lifted by the arm member is illustrated, but the present invention is not limited to this. In one or more embodiments of the present invention, a carriage may be configured so that the entire ink cartridge is lifted by the arm member.

In addition, in the embodiments of the aforementioned first and second examples, an example in which an arm member is provided on only one side in the horizontal direction of the front member is illustrated, but the present invention is not limited to this. In one or more embodiments of the present invention, arm members may be provided on both sides in the horizontal direction of the front member. In this case, elevated portions may be provided on both sides in the horizontal direction of the upper member.

In addition, in the embodiments of the aforementioned second and third examples, an example in which a biasing portion on the arm member is configured by a resin spring is illustrated, but the present invention is not limited to this. In one or more embodiments of the present invention, the biasing portion on the arm member may be configured by a biasing portion other than a resin spring. For example, in one or more embodiments the aforementioned second example, a torsion spring may be provided on the rotary shaft of the arm member as the biasing portion.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### DESCRIPTION OF REFERENCE NUMERALS

1, 101, 201 Carriage
3 Ink Cartridge
10 Carriage Body Portion
20, 120 Upper Member (First Cover)
23 Engaging Portion (First Engaging Portion)
30, 130, 230 Front Member (Second Cover)
41 Engaging Portion (Second Engaging Portion)
42 Pinching Portion (Opening and Closing Operation Portion)
44 Rotary Shaft
124 Elevated portion
124c Inclined Surface
150, 250 Arm Member
153, 253 Biasing Portion
100, 200, 300 Image Forming Apparatus

What is claimed is:

1. An image forming apparatus, comprising:
a carriage that holds an ink cartridge;
a first cover that pushes a first side of the ink cartridge downward; and
a second cover that pushes a second side of the ink cartridge in a direction opposite to a paper feeding direction, wherein
the first cover comprises a first engaging portion,
the second cover comprises a second engaging portion and a pinching portion, and is openable by the pinching portion in the paper feeding direction, and
the first cover and the second cover push the ink cartridge when the first engaging portion and the second engaging portion are engaged and the second cover is closed.

2. The image forming apparatus according to claim 1, wherein
the second cover comprises a rotary shaft, and
the pinching portion pivots around the rotary shaft.

3. The image forming apparatus according to claim 1, wherein
the second cover comprises a biasing member that applies a bias force and keeps the first engaging portion and the second engaging portion engaged.

4. The image forming apparatus according to claim 1, wherein
when the first engaging portion and the second engaging portion are engaged, a front part of the first engaging portion on a side of the paper feeding direction contacts a part of the second engaging portion and is subject to a biasing force from the part of the second engaging portion in the direction opposite the paper feeding direction, and a bottom part of the first engaging portion on a side of a downward direction contacts another part of the second engaging portion and is subject to another biasing force from the other part of the second engaging portion in a direction opposite the downward direction.

5. The image forming apparatus according to claim 1, further comprising
a support shaft that supports the second cover, wherein
the second cover pivots around the support shaft.

6. The image forming apparatus according to claim 1, wherein
the first cover comprises an elevated portion,
the second cover comprises an arm member, and
when the second cover is opened in the paper feeding direction, the arm member contacts the elevated portion and lifts the first cover.

7. The image forming apparatus according to claim 6, wherein
the elevated portion comprises an inclined surface that guides the arm member toward a separating direction that separates the arm member from the first engaging portion.

8. The image forming apparatus according to claim 6, wherein
the arm member is attached to the second cover by a rotary shaft, and
the arm member pivots around the rotary shaft.

9. The image forming apparatus according to claim 7, wherein
the arm member comprises a biasing portion that biases the arm member in a direction opposite to the separating direction.

10. The image forming apparatus according to claim 9, wherein
the biasing portion is elastic and deforms when biasing the arm member.

11. The image forming apparatus according to claim 7, wherein
the inclined surface is inclined at an angle greater than or equal to 5 degrees and less than or equal to 70 degrees in the direction opposite the paper feeding direction with respect to a direction in which the carriage moves together with the ink cartridge for printing.

12. The image forming apparatus according to claim 6, wherein
the arm member is plate-shaped and comprises:
a contacting portion that contacts the second cover; and
a biasing portion arranged on an opposite side of the contacting portion on the arm member, and
the biasing portion biases the arm member in a direction opposite to a separating direction that separates the arm member from the first engaging portion.

13. The image forming apparatus according to claim 1, wherein
the first cover comprises a pair of rail portions that holds a flange portion of the ink cartridge upward when the second cover is opened in the paper feeding direction.

14. The image forming apparatus according to claim 13, wherein
when the second cover is closed, the pair of rail portions separates from the flange portion and does not hold the flange portion.

15. The image forming apparatus according to claim 1, wherein
the first cover comprises a first pushing member made of a plate spring that contacts a top surface of the ink cartridge and pushes the ink cartridge downward.

16. The image forming apparatus according to claim 15, wherein
the second cover comprises a second pushing member made of a plate spring that contacts a front surface of the ink cartridge and pushes the ink cartridge in the direction opposite the paper feeding direction.
